(19) United States
(12) Patent Application Publication
(10) Pub. No.: US 2004/0079787 A1
(43) Pub. Date: Apr. 29, 2004

(54) Friction stir welding method and friction stir welding apparatus

(76) Inventors: Kazutaka Okamoto, Hitachi (JP); Satoshi Hirano, Hitachi (JP); Masayuki Doi, Hitachinaka (JP); Masahisa Inagaki, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/642,167

(22) Filed: Aug. 18, 2003

(30) Foreign Application Priority Data
Oct. 23, 2002 (JP) 2002-307782

(51) Int. Cl. B23K 20/12

(52) U.S. Cl. 228/112.1; 228/2.1

(57) ABSTRACT

The invention provides a discontinuous friction stir welding apparatus and welding method having a compact machine head capable of corresponding to a wide usage. In a friction stir welding apparatus provided with a tool (1) having a shoulder portion (1a) with a large diameter and a pin portion (1b) with a small diameter protruding in an axial direction, and welding by inserting the tool to a material to be welded while rotating the tool, the tool, a moving mechanism of the tool and a backing member (5) for the welded material are received in one frame (10). The tool moving mechanism has a main axis motor (2) for rotating the tool, an axial moving apparatus (4, 13a, 13b, 14) for moving the tool in a direction of a rotation axis, and a welding direction moving apparatus (9, 17) for moving the tool along a weld line of the welded material. Since the apparatus in accordance with the invention is structured such as to weld a short distance in a state of gripping a part of the welded material, it is possible to apply the welding apparatus to the welded material having a complex shape and being hard to be moved.

### BACKGROUND OF THE INVENTION

1. Field of the Invention

The present invention relates to a friction stir welding method and a friction stir welding apparatus of inserting a tool having a shoulder portion and a pin portion into a material to be welded while rotating the tool, thereby achieving a welding by utilizing a frictional heat and a plastic flow which are generated between the tool and the welded material.

2. Description of the Prior Art

A friction stir welding (hereinafter, refer to FSW) has one feature that the welded material can be solid-phase welded under a temperature equal to or less than a melting point. This is suitable for welding an aluminum, a copper, a magnesium or alloys thereof. In the FSW, a tool made of a material harder than the welded material applies a load to the welded material while rotating and is inserted to the welded material. Accordingly, in accordance with a normal method, a backing metal is applied to a back face of the welded material (refer, for example, to JP-A-11-230320).

Further, there has been proposed a spot welding method of point welding in place of continuously welding along a weld line of the welded material (refer, for example, to JP-A-2001-314982).

The normal FSW executing method of continuously welding along the weld seam of the welded material in a state of inserting the pin portion of the tool to the welded material is hard to be applied to the welded material having a complex shape. In the case that the welded material has a curved shape, it is not easy to make a backing member to closely contact with all the area of the weld line of the welded material. It is hard to move the tool in a state of keeping a pin insertion depth to the welded material constant. There can be considered a method of moving the backing member in correspondence to the movement of the tool by using a small backing member, however, in this method, since it is necessary to move a device for pressing the backing member to the welded material together, a range of application is limited.

A method of spot-welding in accordance with the FSW is also limited in a range of application in view of a welding strength.

### SUMMARY OF THE INVENTION

An object of the present invention is to improve an FSW apparatus so that the FSW can be applied even to the welded material having the complex shape, and to contrive a welding method.

In accordance with the present invention, there is provided a friction stir welding apparatus provided with a tool having a shoulder portion with a large diameter and a pin portion with a small diameter protruding in an axial direction, inserting the tool to a material to be welded while rotating the tool, and welding by utilizing a frictional heat and a plastic flow phenomenon which are generated between the tool and the welded material, wherein the tool, a moving mechanism of the tool and a backing member of the welded material are received in one frame.

A backing member moving apparatus for pressing up the backing member toward the welded material may be received in the frame.

In accordance with the present invention, the welded material is held between the backing member and the tool, and the pin portion is inserted to the welded material by moving the tool in a direction of a rotation axis while rotating the tool. Further, only the tool is moved along a weld line of the welded material without moving the frame. Since the frame does not move, a length capable of being welded is limited by itself. The weld length per one time will be some tens mm at the longest. After a desired length, for example, some mm to some tens mm length is welded, a new position to be welded is brought just below the tool by pulling out the tool from the welded material and moving the welded material or moving the frame. Then, the new welded position is again welded. All the area of the weld line of the welded material is discontinuously, that is, intermittently welded by repeating the operation at plural times.

In accordance with a more preferable aspect, a fixing jig for clamping the welded material and a moving apparatus thereof are received in the frame, and the welded material is welded in a state in which the welded material is clamped by the backing member and the fixing jig.

Thus, in accordance with an aspect the present invention, there is provided a friction stir welding method of applying a backing member to a back face of a material to be welded, inserting a tool having a pin portion with a small diameter in a leading end of a shoulder portion with a large diameter to the welded material by the pin portion while rotating the tool, and welding by utilizing a friction heat and a plastic flow generated between the tool and the welded material, wherein the tool, a moving mechanism of the tool and the backing material are received in one frame, the pin portion is inserted to the welded material while the tool is rotated with holding the welded material between the backing member and the tool, and the welding is carried out by moving only the tool in a weld line direction of the welded material without moving the frame.

Further, in the above aspect, the structure may be made such that the pin portion is pulled out from the welded material after a part of the welded material is welded by moving the tool in the weld line direction of the welded material at a desired distance, and the welded material is again welded at a desired distance by moving one of the frame and the welded material, whereby the welded material is discontinuously welded in the weld line direction by repeating the above operation.

Further, in the above aspect, the structure may be made such that the tool is rotated by a main axis motor, and the pin portion is inserted to the welded material until an electric current value of the main axis motor reaches a predetermined value.

In accordance with another aspect of the present invention, there is provided a friction stir welding method of inserting a tool having a shoulder portion and a pin portion to a material to be welded by the pin portion while rotating the tool, and welding by utilizing a friction heat and a plastic flow generated between the tool and the welded material, wherein the welded material is discontinuously welded along a weld line direction of the welded material.

Further, in the above aspects, the structure may be made such that a weld length per one time is between 5 and 20 mm.

In accordance with the other aspect of the present invention, there is provided a friction stir welding apparatus provided with a tool having a shoulder portion with a large diameter and a pin portion with a small diameter protruding in an axial direction, and welding by inserting the tool to a material to be welded while rotating the tool, wherein the tool, a moving mechanism of the tool and a backing member for the welded material are received in one frame.

Further, in the above aspect, the structure may be made such that the tool moving mechanism has a main axis motor for rotating the tool, an axial moving apparatus for moving the tool in a direction of a rotation axis, and a welding direction moving apparatus for moving the tool along a weld line of the welded material.

Still further, in the above aspect, the structure may be made such that a welded material fixing jig for pressing the welded material from a side from which the tool is inserted, and a moving apparatus of the welded material fixing jig are received in the frame.

Furthermore, in the above aspect, the structure may be made such that the main axis motor is constituted by any one of a spindle motor, an induction motor and a servo motor.

Further, in the above aspect, the structure may be made such that the movements of the tool achieved by the axial direction moving apparatus and the welding direction moving apparatus are both carried out by a servo motor.

Still further, in the above aspect, the structure may be made such that the movements of the fixing jig achieved by the fixing jig moving apparatus is carried out by a servo motor.

Furthermore, in the above aspect, the structure may be made such that the movements of the tool achieved by the axial direction moving apparatus and the welding direction moving apparatus are both carried out by a hydrostatic cylinder.

Further, in the above aspect, the structure may be made such that the movements of the fixing jig achieved by the fixing jig moving apparatus is carried out by a hydrostatic cylinder.

Still further, in the above aspect, the structure may be made such that the friction stir welding apparatus is further provided with an electric current detector for detecting an electric current value of the main axis motor, an arithmetic unit for determining an amount of insertion of the tool to the welded material in correspondence to the electric current value of the main axis motor detected by the electric current detector, and a control unit for controlling the amount of insertion of the tool to the welded material.

Furthermore, in the above aspect, the structure may be made such that the fixing jig has an I-shaped groove along a weld line of the welded material, and the welding direction moving apparatus is structured such as to move the tool along the I-shaped groove.

Further, in the above aspect, the structure may be made such that the frame is formed in a C shape.

Still further, in the above aspect, the structure may be made such that the frame is mounted to a leading end of a robot arm.

In accordance with the present invention, since the tool, the moving apparatus thereof and the backing member are received in one frame, the FSW apparatus can be made compact. In the case that the length of the weld line is large, the welding can be achieved by moving the frame or moving the welded material, so that a lot of space is not taken for welding. Even in the case of the welded material having a complex shape with a curved surface, since the welded member is clamped in just a part thereof, it is easy to apply the method and apparatus in accordance with the present invention.

Other objects, features and advantages of the invention will become apparent from the following description of the embodiments of the invention taken in conjunction with the accompanying drawings.

### BRIEF DESCRIPTION OF THE DRAWINGS

FIG. 1 is a plan view of a C-type head showing one embodiment in accordance with the present invention;

FIG. 2 is a side elevational view of a C-type head showing one embodiment in accordance with the present invention;

FIG. 3 is a perspective view of a friction stir welding apparatus in accordance with the present invention near a tool;

FIG. 4 is a perspective view showing a friction stir welding method in accordance with the present invention;

FIG. 5 is a schematic view of a friction stir welding apparatus in which a C-type head is mounted to a general purpose robot arm;

FIG. 6 is a photograph showing a microstructure in a cross section of a welded portion obtained by the method in accordance with the present invention;

FIG. 7 is a perspective view showing a shape and a size of a strength evaluating test piece employed in the embodiment in accordance with the present invention;

FIG. 8 is a view showing a shearing load for making nondimensional of a sample obtained by the embodiment in accordance with the present invention; and

FIG. 9 is a relation view between the shearing load for making nondimensional of the sample obtained by the embodiment in accordance with the present invention and a cycle.

### DESCRIPTION OF THE PREFERRED EMBODIMENT

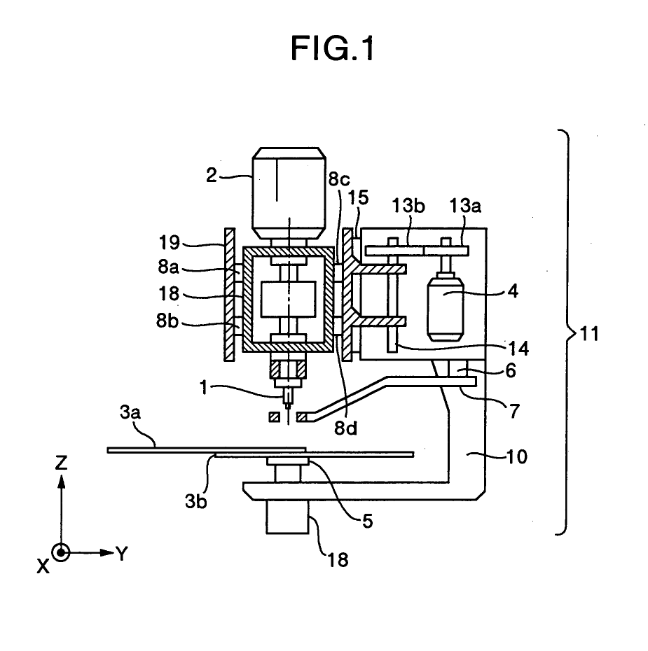

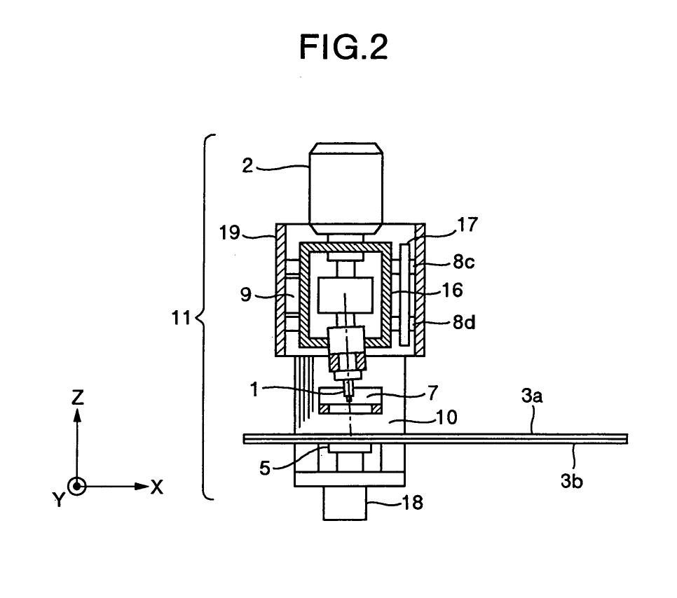

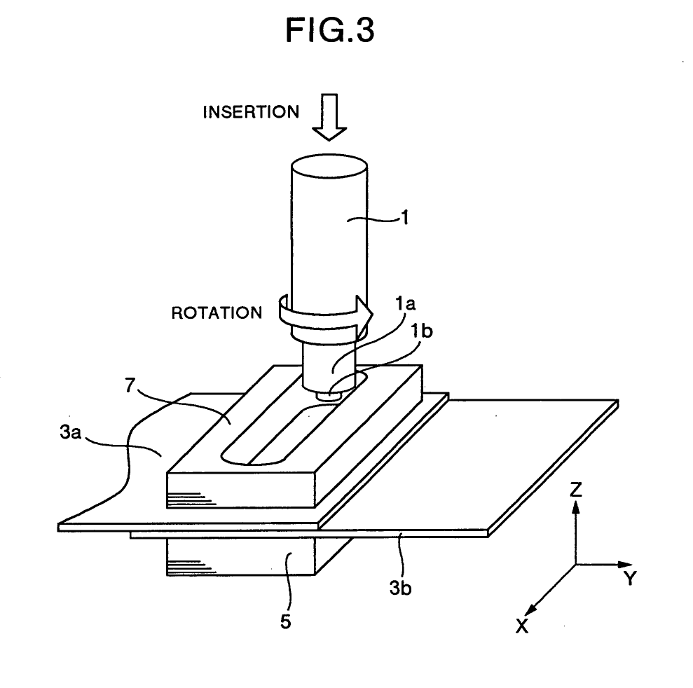

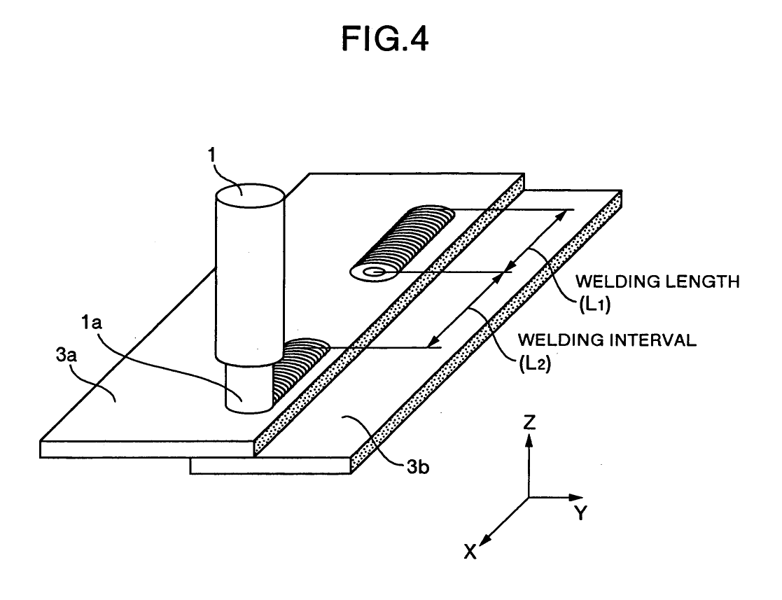

A description will be given of an outline of a structure and a motion of a friction stir welding apparatus in accordance with the present invention with reference to the accompanying drawings. FIGS. 1 and 2 are views of a C-type head 11 as seen from an X-axis and a Y-axis in an expediently set rectangular coordinate system. Further, FIG. 3 is a perspective view obtained by enlarging a portion near a welded portion. The C-type head 11 forms a minimum unit of an FSW apparatus in accordance with the present invention. The C-type head 11 in accordance with the present embodiment has a C-type frame 10, and a tool 1, a tool moving apparatus, a backing member 5, a moving apparatus of the backing member, a fixing jig 7 for clamping a material to be welded, and a moving apparatus of the fixing jig are received in the C-type frame 10. Each of the moving apparatus of the backing member 5 and the moving apparatus of the fixing jig 7 is preferably constituted by a hydrostatic cylinder, and is provided with hydraulic cylinders 6 and 18 in the present embodiment. The tool 1 is rotated by a main axis motor 2. An apparatus for moving the tool in a direction of rotation axis has a motor 4, a ball screw 14, gears 13a and 13b and a guide 15. The structure is made such that the gears 13a and 13b and the ball screw 14 are rotated by the motor 4, and a machine head 16 received in a machine head casing 19 is guided by a guide 15 so as to move up and down. Since the tool is mounted to the machine head 16, the tool 1 also moves up and down.

A welding direction moving apparatus for moving the tool along a weld line of the welded material has a cylinder 9 for moving the machine head 16, guides 8a, 8b, 8c and 8d and a stopper 17. The machine head 16 is guided by the guides 8a, 8b, 8c and 8d by driving the cylinder 9 so as to move along a weld line of the welded materials 3a and 3b, and is brought into contact with the stopper 17 so as to stop. It is possible to change a moving amount of the tool in the welding direction by adjusting a position of the stopper 17.

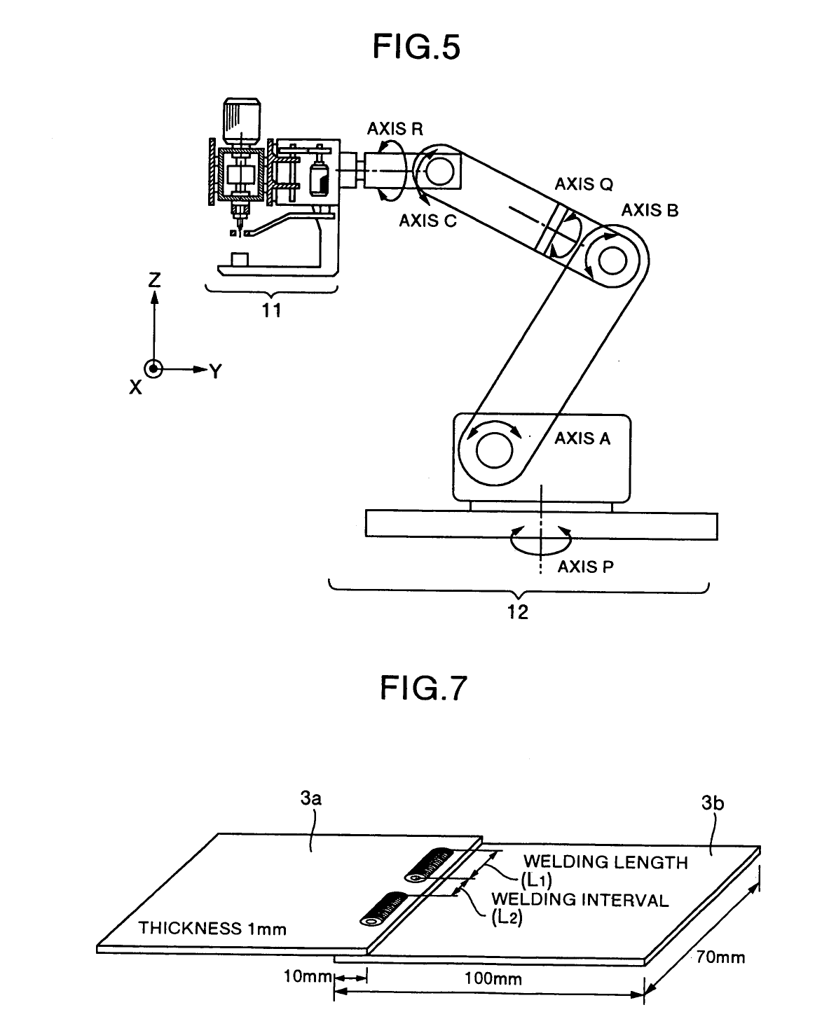

The C-type head 11 constituting the minimum unit of the FSW apparatus can be mounted to a leading end of a robot arm 12 as shown in FIG. 5. The robot arm 12 in FIG. 5 has joint axes comprising an A shaft, a B shaft and a C shaft, and rotation axes comprising a P shaft, a Q shaft and an R shaft.

After the backing member 5 is closely contacted to the lower welded material 3b so as to be positioned by the robot arm 12, the fixing jig 7 is moved by driving the hydraulic cylinder 6, and the welded materials 3a and 3b are clamped by the fixing jig 7 and the backing member 5. Next, the tool is rotated by the main axis motor 2. A number of rotation depends upon a material and a shape of the welded material, however, is about 1000 to 3000 rpm. Next, the tool is moved down by driving the motor 4, and the pin portion is inserted to the welded material at a predetermined depth. The tool 1 is provided with a shoulder portion 1a and a pin portion 1b as shown in FIG. 3. The predetermined depth is controlled as a depth obtained in the case that a current value of main axis motor 2 or a current value of the motor 4 for the axial movement is monitored and reaches a predetermined current value. That is, the pin is pressed into the welded material until the current value of the main axis motor 2 or the motor 4 for the axial movement reaches the predetermined value. In a state in which the tool is inserted to the welded material, the cylinder 9, for example, the hydrostatic cylinder is driven, the tool is moved to an upper side by the motor 4 at a time when a desired distance is welded, and the machine head 16 is returned to an original position. Next, a next welded position is brought to the position of the tool by moving the welded materials 3a and 3b or moving the C-type head 11. Then, a desired distance is welded by again executing the same operation.

In the FSW apparatus in accordance with the present invention, the main axis motor preferably employs a spindle motor, an induction motor or a servo motor. Further, the motor for moving the tool up and down in the direction of rotation axis preferably employs a servo motor. The welding direction moving cylinder for moving the tool in the direction of the weld line and the hydrostatic cylinder for moving the fixing jig preferably employ a hydraulic driven cylinder taking a response into consideration.

It is preferable that an I-shaped groove is formed in the fixing jig 7 for clamping the welded material, and the tool 1 is moved along an inner side of the groove. The welded materials 3a and 3b are firmly fixed near the welded portion by forming the fixing jig 7 in the shape mentioned above, thereby being effectively prevented from being deformed. It is important that the C-type head 11 is made more compact in any of the devices.

A robot type friction stir welding apparatus in which the C-type head 11 in accordance with the present invention is manufactured by way of trial, and a lap welding of an aluminum is executed. FIG. 5 shows an outline of the robot type friction stir welding apparatus. The C-type head 11 is placed in a leading end of a general purpose robot arm 12. Each of the welded materials 3a and 3b is an aluminum material constituted by A5083 having a thickness of 1 mm. A pressing force of the hydraulic cylinder 6 for moving the fixing jig 7 is set to 200 kgf. The tool 1 is made of a tool steel to which a heat treatment is applied, a diameter of the shoulder portion 1a is set to 7 mm, a diameter of the pin portion 1b is set to 3 mm, a length of the pin portion 1b is set to 1.5 mm, and a screwed spiral groove is provided on a surface of the pin portion 1b. The main axis motor 2 employs a spindle motor having an output of 4 kW, and a number of rotation of the main axis motor 2 is set to 1000 rpm. An inserting amount of the rotating tool 1 to the welded material 3a is set to 1.5 mm, and an inserting speed is set to 30 mm/sec. A driving force of the cylinder 9 for moving the machine head 16 in a welding direction is set to 50 kgf.

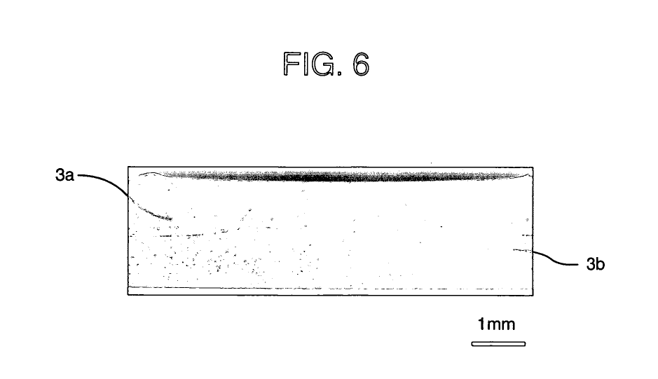

FIG. 6 shows a microstructure in a cross section of the welded portion in the welded material which is welded under the condition mentioned above. The welded materials 3a and 3b are welded with no defect.

Next, a welding length (L1) and a welding interval (L2) are changed to various values, and a welding test is tried. As shown in FIG. 7, a sample is an aluminum material constituted by A5083 having a thickness of 1 mm, a width of 70 mm and a length of 100 mm. An overlapping width is set to 10 mm. The welding condition is set to the same as mentioned above, and the welding direction is set to a width direction. The welding length (L1), the welding interval (L2), a number of welding beads and a total welding length are shown in Table 1.

TABLE 1

| | | | NUMBER | | |
|---|---|---|---|---|---|
| | | | OF | TOTAL | |
| SAMPLE | WELDING | WELDING | WELDING | WELDING | |
| No. | LENGTH | INTERVAL | BEADS | LENGTH | NOTES |
| 1 | 0 | 14 | — | 0 | SPOT WELDING |
| | | | | | (NUMBER OF |
| | | | | | WELDING |
| | | | | | POINTS: 10) |
| 2 | 5 | 6 | 6 | 30 | INTERMITTENT |
| | | | | | WELDING |
| 3 | 10 | 10 | 3 | 30 | INTERMITTENT |
| | | | | | WELDING |
| 4 | 15 | 10 | 2 | 30 | INTERMITTENT |
| | | | | | WELDING |
| 5 | 30 | 0 | 1 | 30 | CONTINUOUS |
| | | | | | WELDING |

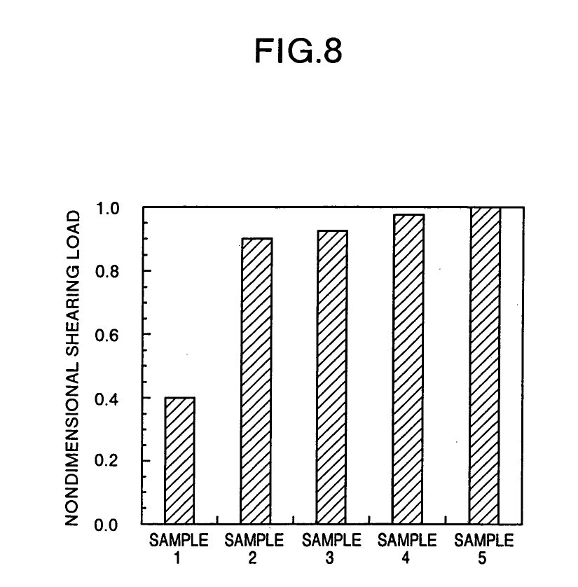

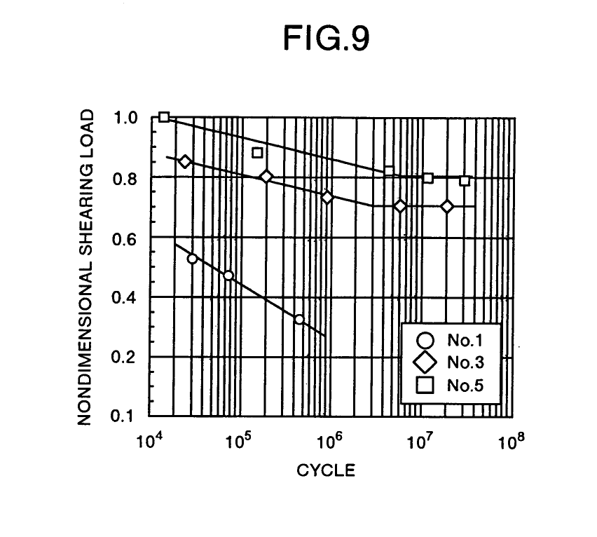

A sample No. 1 is obtained by spot welding, and a sample No. 5 is obtained by continuously welding. Sample Nos. 2 to 5 are obtained by intermittently welding, and each of them has a total welding length of 30 mm. Shearing loads obtained by applying a shearing test in a longitudinal direction to these samples are shown in FIG. 8. In this case, a vertical axis is normalized by a breaking load of the sample No. 5 (a nondimensional shearing load obtained by setting a breaking load of the sample No. 5 to 1). As a result, the breaking loads of the samples 2 to 4 are slightly lower than that of the sample No. 5 obtained by continuously welding, however, indicate a breaking load equal to or more than 90%. On the other hand, the breaking load becomes extremely low in the spot welding of the sample No. 1, and only about a half of the strength of the intermittent welding is obtained in spite of a lot of welding points. Further, shearing loads obtained by applying a shearing fatigue test to some of the samples are shown in FIG. 9. In this case, a vertical axis is also normalized by a breaking load of the sample No. 5. A fatigue strength of the welded portion of the intermittently welded sample No. 3 is slightly inferior to that of the continuously welded sample No. 5, however, indicates an excellent fatigue strength. However, in the spot welded sample No. 1, the fatigue strength is significantly lowered. On the basis of these results, it is desirable that the welding length per one time is set to a range between 5 and 20 mm.

On the basis of the embodiments mentioned above, it can be confirmed that the intermittent linear welding is superior to the simple spot welding. The FSW apparatus in accordance with the present invention is characterized in a point that all the linear welding functions are built in the C-type head 11. In accordance with this structure, in spite that the relative position relation between the C-type head 11 and the welded materials 3a and 3b is not changed, the linear welding can be achieved all along the desired length. The welding length at one time is some tens mm and is shorter than the continuous welding, however, the strength of the welded portion can be secured by intermittently welding. Even in the case that the welded material having the complex shape, since the backing member of the C-type head is applied only a part of the welded material, the present invention can be applied. Further, with respect to the welded material which is hard to be moved, it is possible to correspond to the case by mounting the C-type head to the leading end of the general purpose robot arm and moving the C-type head. In accordance with the present invention, it is possible to expand the application range of the FSW.

In accordance with the present invention, it is possible to intend to expand the application range of the FSW.

It should be further understood by those skilled in the art that the foregoing description has been made on embodiments of the invention and that various changes and modifications may be made in the invention without departing from the spirit of the invention and the scope of the appended claims.

What is claimed is:

1. A friction stir welding method of applying a backing member to a back face of a material to be welded, inserting a tool having a pin portion with a small diameter in a leading end of a shoulder portion with a large diameter to the welded material by said pin portion while rotating the tool, and welding by utilizing a friction heat and a plastic flow generated between said tool and the welded material, wherein said tool, a moving mechanism of the tool and said backing material are received in one frame, said pin portion is inserted to the welded material while said tool is rotated with holding the welded material between said backing member and said tool, and the welding is carried out by moving only said tool in a weld line direction of the welded material without moving said frame.

2. A friction stir welding method as claimed in claim 1, wherein said pin portion is pulled out from the welded material after a part of the welded material is welded by moving said tool in the weld line direction of the welded material at a desired distance, and the welded material is again welded at a desired distance by moving one of said frame and the welded material, whereby the welded material is discontinuously welded in the weld line direction by repeating the above operation.

3. A friction stir welding method as claimed in claim 1, wherein said tool is rotated by a main axis motor, and said pin portion is inserted to the welded material until an electric current value of said main axis motor reaches a predetermined value.

4. A friction stir welding method of inserting a tool having a shoulder portion and a pin portion to a material to be welded by said pin portion while rotating the tool, and welding by utilizing a friction heat and a plastic flow generated between said tool and the welded material, wherein said welded material is discontinuously welded along a weld line direction of the welded material.

5. A friction stir welding method as claimed in claim 1, wherein a weld length per one time is between 5 and 20 mm.

6. A friction stir welding method as claimed in claim 4, wherein a weld length per one time is between 5 and 20 mm.

7. A friction stir welding apparatus provided with a tool having a shoulder portion with a large diameter and a pin portion with a small diameter protruding in an axial direction, and welding by inserting said tool to a material to be welded while rotating said tool, wherein said tool, a moving mechanism of the tool and a backing member for the welded material are received in one frame.

8. A friction stir welding apparatus as claimed in claim 7, wherein said tool moving mechanism has a main axis motor for rotating said tool, an axial moving apparatus for moving said tool in a direction of a rotation axis, and a welding direction moving apparatus for moving said tool along a weld line of the welded material.

9. A friction stir welding apparatus as claimed in claim 7, wherein a welded material fixing jig for pressing the welded material from a side from which said tool is inserted, and a moving apparatus of the welded material fixing jig are received in said frame.

10. A friction stir welding apparatus as claimed in claim 8, wherein said main axis motor is constituted by any one of a spindle motor, an induction motor and a servo motor.

11. A friction stir welding apparatus as claimed in claim 8, wherein the movements of said tool achieved by said axial direction moving apparatus and said welding direction moving apparatus are both carried out by a servo motor.

12. A friction stir welding apparatus as claimed in claim 9, wherein the movements of said fixing jig achieved by said fixing jig moving apparatus is carried out by a servo motor.

13. A friction stir welding apparatus as claimed in claim 8, wherein the movements of said tool achieved by said axial direction moving apparatus and said welding direction moving apparatus are both carried out by a hydrostatic cylinder.

14. A friction stir welding apparatus as claimed in claim 9, wherein the movements of said fixing jig achieved by said fixing jig moving apparatus is carried out by a hydrostatic cylinder.

15. A friction stir welding apparatus as claimed in claim 8, further comprising an electric current detector for detecting an electric current value of said main axis motor, an arithmetic unit for determining an amount of insertion of said tool to the welded material in correspondence to the electric current value of the main axis motor detected by said electric current detector, and a control unit for controlling the amount of insertion of said tool to the welded material.

16. A friction stir welding apparatus as claimed in claim 9, wherein said fixing jig has an I-shaped groove along a weld line of the welded material, and said welding direction moving apparatus is structured such as to move said tool along said I-shaped groove.

17. A friction stir welding apparatus as claimed in claim 7, wherein said frame is formed in a C shape.

18. A friction stir welding apparatus as claimed in claim 7, wherein said frame is mounted to a leading end of a robot arm.
